(19) United States
(12) Patent Application Publication
(10) Pub. No.: US 2024/0335966 A1
(43) Pub. Date: Oct. 10, 2024

(54) QUILTING TEMPLATE AND METHOD OF USING SAME

(71) Applicant: Lauri Kim REMIN, Edmonton (CA)

(72) Inventor: Lauri Kim REMIN, Edmonton (CA)

(21) Appl. No.: 18/747,700

(22) Filed: Jun. 19, 2024

Related U.S. Application Data
(63) Continuation-in-part of application No. 17/930,407, filed on Sep. 7, 2022.

(51) Int. Cl. B26B 29/06; D06H 7/00

(52) U.S. Cl. CPC B26B 29/06; D06H 7/00

(57) ABSTRACT

A fabric cutting template for quilting and a method of use thereof. The template contains two differently sized cutting slots to enable a rotary fabric cutter to completely cut a specific shape from the template without additional marking of the fabric. The template is designed for use with commonly know 10-inch fabric squares or “layer cakes”.

### FIELD OF THE INVENTION

The present specification relates generally to a template for use with rotary cutters for cutting fabric into pieces to be assembled into quilts, and more particularly to a template for precisely cutting specific shapes with reduced wastage.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

One of the primary techniques involved in quilt making is patchwork, which involves sewing together geometric pieces of fabric to form a design or block. The geometric pieces, designs or blocks are sewn together into a larger design. The larger design is usually based on repeating patterns built up with different fabric shapes, which are typically different colors and designs of fabric. These shapes must be carefully measured and cut in order for them to piece together accurately and produce a finished quilt top that lies flat.

In the past, the geometric shapes were measured with a ruler, marked and cut with scissors. Modern quilting techniques have evolved into using templates, cutting boards and rotary cutters to produce the various different geometric shaped and sized pieces of fabric to be sewn into a quilt top.

Quilting templates are shapes made to outline edges for cutting the patchwork geometric pieces. Known templates are generally plastic with markings for different sizes, sewing lines or placement marks and are thick enough that they can be used with a rotary cutter. The benefits of using a quilting template for patchwork allows the pieces to be cut exactly the same size for the entire quilt top and are thick enough to be used with a rotary cutter. Known templates, however, have several disadvantages in regards to fabric wastage.

A user currently does not have a failsafe method for cutting corners out of the fabric or material for making manual cuts using a ruler, scissors or by using a rotary cutter or other cutting tool. A quilter currently uses an existing ruler or template shape, measures and lines up the bottom and sides of the ruler or template shape to the user's desired location, draws with a marking tool along the edges of the ruler or template shape the two edges to be cut out, then the user removes the ruler or template shape and uses scissors to cut the square out of the fabric corner. This process is time consuming, and if the quilter uses a rotary cutter, can often cut past the outer edges of the ruler or template shape which results in significant fabric wastage leaving less usable fabric or material. A quilter often desires to make these types of cuts in fabric or material to make a “box corner” or cut certain measurements of fabric or material from yardage. For instance, rag quilts that require many numerous equally spaced repeated cuts into an outer each raw edge side of the fabric or material. This type of cutting can be very strenuous for the individual user to be cutting the required number of cuts through multiple layers of fabric or material. Equally spaced cuts are required to be cut along the quilt cut or raw edges so the completed quilt has a “rag” look. Numerous cuts are required to be cut and cutting these with scissors repeatedly can easily cause carpel tunnel injuries, hand and arm fatigue, and often results in overcutting some of the cuts into the seams, resulting in seam repairs, wasted fabric or material and time

With increasing fabric and material costs, reducing the amount of fabric or material waste is paramount. Given that some quilt and bag patterns may have 200 plus pieces or more, cutting pieces for quilt and bag making patterns can take a significant amount of time for the user.

While there are some templates known in the art, it would be desirable to have a template which mitigates some of the existing disadvantages. It is clear that there exists a need for a fabric cutting device for precisely cutting patchwork pieces of fabric, including corners and slits in fabrics and materials. There is need for a fabric cutting device that allows a user to precisely cut corners, outlines and shapes in fabrics that reduces fabric and materials waste, reduces effort and increases efficiency.

Accordingly, there remains a need for improvements in the art.

### SUMMARY OF THE INVENTION

In accordance with an aspect of the invention, there is provided a method of cutting multiple layers of fabric using a rotary cutter, comprising: placing a cutting template on a top layer of fabric of the multiple layers of fabric, the cutting template comprising: a rigid planar square body dimensioned to the layers of fabric, a triangular notch in one side of the square body, the triangular notch being an equilateral triangle shape, with a top point, a left side and a right side, a first cutting slot extending from the top point of the triangular notch and extending from the right side, a second cutting slot extending from the top point of the triangular notch and extending from the left side, the second cutting slot being longer than the first cutting slot. Next, aligning the cutting template on the top layer of fabric such that the triangular notch is positioned along a bottom edge of the top layer of fabric, performing a first cut with the rotary cutter along the right edge of the triangular notch and finishing at the shorter cutting slot, performing a second cut with the rotary cutter along the left edge of the triangular notch and finishing at the longer cutting slot. The cutting template is then rotated 90 degrees, and then the first cutting step and second cutting step are repeated with the rotating and cutting steps repeated three times. The output of the method is four five-sided pieces, one square piece and four triangular pieces from each layer of fabric.

The cutting steps may cut through more than one layer of the multiple layers of fabric or through all layers of the multiple layers of fabric.

Additional steps may include applying a non-slip spray to the top layer of fabric prior to the step of placing the template on the top layer of fabric and/or removing the triangular pieces of fabric prior to the rotating step.

According to another embodiment of the invention, there is provided a fabric cutting template, comprising: a rigid planar square body, a triangular notch in one side of the square body, the triangular notch being an equilateral triangle shape, with a top point, a left side and a right side, a first cutting slot extending from the top point of the triangular notch and extending from the right side, and a second cutting slot extending from the top point of the triangular notch and extending from the left side, the second cutting slot being longer than the first cutting slot, wherein the fabric cutting template is operative to provide a template for cutting one or more layers of fabric with a rotary cutter

According to a further embodiment of the invention, the fabric cutting template may further comprising one or more markings on the cutting template, the markings comprising one or more reference lines equivalent to the triangular notch, the shorter cutting slot, and the longer cutting slot along one or more additional sides of the square body.

The fabric cutting template may further include markings for cutting instructions, the cutting instructions comprised of one or more of: text, arrows, pictograms and combinations thereof.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a top planar view of a quilting template according to an embodiment;

FIG. 2 is a top planar view of the quilting template of FIG. 1 with additional markings;

FIG. 3 is a flowchart of a method of use for the template of FIG. 1; and

FIG. 4 is a top planar view of an alternate embodiment of a quilting template.

Like reference numerals indicated like or corresponding elements in the drawings.

### DETAILED DESCRIPTION OF THE EMBODIMENTS

The present invention relates to a quilting template and, in particular, a quilting template for use with a rotary fabric cutting tool.

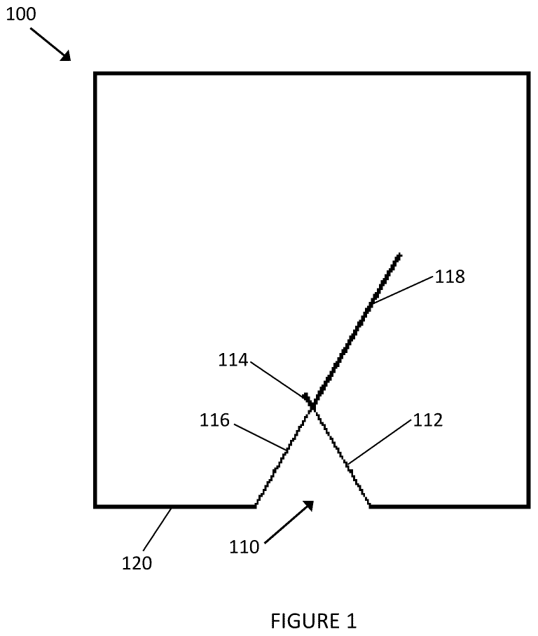

According to an embodiment as shown in FIG. 1, the template 100 is formed as a four-sided frame, preferably square in shape for use with square-shaped piece of fabric, such as the “layer cakes” as known in the art. An equilateral triangular cutout or notch 110 is positioned on one of the sides, referred to herein as the bottom side 120. Extending from the right side 112 of the notch 110 is a first cutting slot 114, and extending from the left side 116 or the notch 110 is a second cutting slot 118, with first cutting slot 114 being shorter than second cutting slot 118.

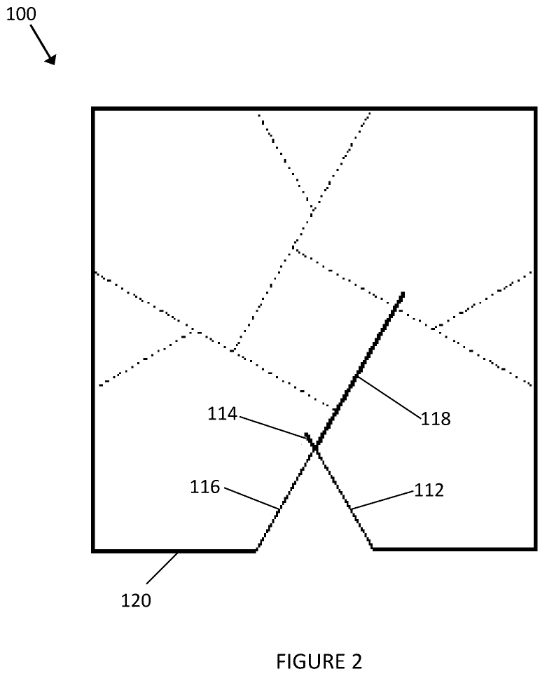

As shown in FIG. 2, markings may be added to indicate the final shapes of fabric that will be cut from template 100. The marking may include reference lines for cutting steps, reference lines for the resulting fabric shapes, and other indicators as applicable to the cutting process, displayed as text, arrows, pictograms or other symbols, individually or in combination.

Template 100 is preferably formed as a rigid body, of single-piece constructions. More preferably, template 100 is formed from a transparent or translucent rigid plastic material.

Referring to FIG. 2, the first cutting slot 114 allows for a rotary cutter to reach the edge and point of the triangular cutout 110. Then, the second cutting slot allows a cut which not only reaches the edge and point of triangular cutout 110, but further extends into the center of the template. As a result, with reference to the markings on FIG. 2, the fabric is cut into nine usable pieces: four pentagonal shapes, four equilateral triangles, and a square. Thus, all nine pieces of fabric as usable for creating various types of quilt tops with significantly reduced wastage in the fabric, as while a reduced marking and cutting of the fabric to achieve this result.

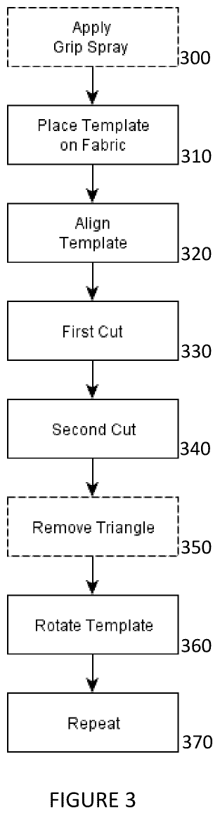

In operation, referring to FIG. 3, template 100 is first placed (310) and aligned (320) on the top layer of fabric such that the triangular notch 110 is positioned along a bottom edge of the top layer of fabric, matching the bottom edge 120 of the template 100.

The first cut (330) is then performed with the rotary cutter along the right edge of the triangular notch 120 and finishing at the first (shorter) cutting slot 114. Next the second cut (340) is performed with the rotary cutter along the left edge of the triangular notch and finishing at the second (longer) cutting slot 118. The resulting triangular piece of fabric may be removed (350) at this point, if desired.

The template 100 is then rotated 90 degrees (360), and the two cutting steps are repeated (370). The rotating step and cutting steps are repeated two more times (a total of three times) such that the template 100 has been positioned along each edge of the fabric when the process is complete. The resulting cuts produce four five-sided pieces, one square piece and four triangular pieces from the piece of fabric.

While described as cutting a single piece of fabric, it is possible to cut multiple layers of fabric simultaneously, depending on the type of fabrics, numbers of layers, and type of rotary cutter. In an optimal scenario, it may be possible to cut through all layers of a stack of fabric, such as a “layer cake” or similar.

Additionally, it may be desirable to apply a gripping or friction spray (300) to the fabric or the template 100 prior to placing the template 100 on the fabric in order to minimize moving or shifting during the cutting steps. Alternatively, the template 100 may have its surface patterned or coated to provide additional friction with the fabric during the cutting steps.

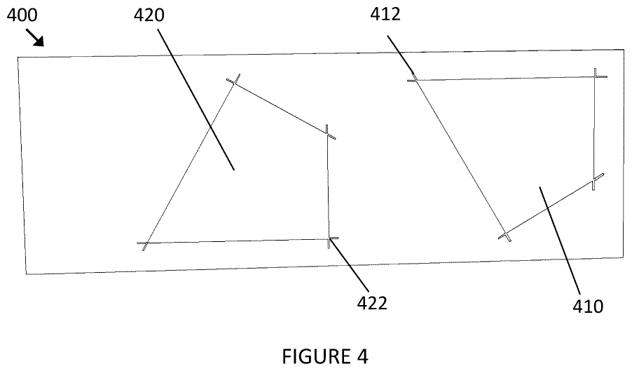

An alternative template 400 is shown in FIG. 4. The template 400 is rectangular, generally for use when cutting pieces from a rectangular section of fabric, particularly those known in the art as a “fat quarter”. A fat quarter of fabric is generally a quarter of a yard (or meter) of fabric, and measures 18″×21″, in contrast to the traditional quarter yard off a fabric bolt, which is generally 9″×42″.

The template 400 contains two quadrilateral cutouts 410, 420, with cutting slots 412, and 422 provided along each edge to permit passage of a rotary cutter to the end corners of each cutout 410. The cutouts 410, 420 are of the same shape, but the second cutout 402 is flipped vertically relative to first cutout 410. An additional cutout marking may also be provided to permit a triangular section to be cut off from the resulting quadrilateral piece to produce a pentagonal fabric piece (similar to those produced by template 100) and a triagonal fabric piece for use in making a quilt or quilt top.

In operation, after the set of cuts are completed for each cutout 410, 420, the template 400 is flipped horizontally and the process repeated in order to maximize the user of the fabric in the “fat quarter” for the templated shapes. For a standard “fat quarter”, four quadrilateral pieces (which may be further cut to 5-sided pieces) are produced.

As shown, the template 100 is a square 10 inches per side, designed to correspond to standard fabric sizing as is known in quilting (commonly referred to as a “layer cake”). The template 100 may be sized up or down as necessary to accommodate different fabric sizes. Example sizes for the square edge length of the fabric, with the corresponding edge length of triangular notch 110, overall length of the triangular edge plus first cutting slot 114 and overall length of the triangular edge plus second cutting slot 118 are shown in Table 1.

TABLE 1

| Square | Triangle | First slot | Second slot |
|---|---|---|---|
| edge | edge | plus edge | plus edge |
| 5″ | 1.34″ | 1.71″ | 3.54 |
| 6″ | 1.61″ | 1.98″ | 4.18″ |
| 7″ | 1.88″ | 2.25″ | 4.81″ |
| 8″ | 2.14″ | 2.52″ | 5.45″ |
| 9″ | 2.41″ | 2.79″ | 6.14″ |
| 10″ | 2.68″ | 3.05″ | 6.71″ |

It should also be noted that the steps described in the method of use can be carried out in many different orders according to user preference. The use of “step of” should not be interpreted as “step for”, in the claims herein and is not intended to invoke an statutory provisions of interpretation. It should also be noted that, under appropriate circumstances, considering such issues as design preference, user preferences, marketing preferences, cost, structural requirements, available materials, technological advances, etc., other methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A method of cutting multiple layers of fabric using a rotary cutter, comprising:
placing a cutting template on a top layer of fabric of the multiple layers of fabric, the cutting template comprising:
a rigid planar square body dimensioned to the layers of fabric,
a triangular notch in one side of the square body, the triangular notch being an equilateral triangle shape, with a top point, a left side and a right side,
a first cutting slot extending from the top point of the triangular notch and extending from the right side,
a second cutting slot extending from the top point of the triangular notch and extending from the left side, the second cutting slot being longer than the first cutting slot,
aligning the cutting template on the top layer of fabric such that the triangular notch is positioned along a bottom edge of the top layer of fabric,
performing a first cut with the rotary cutter along the right edge of the triangular notch and finishing at the shorter cutting slot,
performing a second cut with the rotary cutter along the left edge of the triangular notch and finishing at the longer cutting slot,
rotating the cutting template 90 degrees,
repeating the first cutting and second cutting step,
repeating the rotating and cutting steps three times,
wherein the output of the method is four five-sided pieces, one square piece and four triangular pieces from each layer of fabric.

2. The method of claim 1, wherein the cutting steps cut through more than one layer of the multiple layers of fabric.

3. The method of claim 2, wherein the cutting steps cut through all layers of the multiple layers of fabric.

4. The method of claim 1, further comprising a step of applying a non-slip spray to the top layer of fabric prior to the step of placing the template on the top layer of fabric.

5. The method of claim 1, further comprising removing the triangular pieces of fabric prior to the rotating step.

6. A fabric cutting template, comprising:
a rigid planar square body,
a triangular notch in one side of the square body, the triangular notch being an equilateral triangle shape, with a top point, a left side and a right side,
a first cutting slot extending from the top point of the triangular notch and extending from the right side, and
a second cutting slot extending from the top point of the triangular notch and extending from the left side, the second cutting slot being longer than the first cutting slot,
wherein the fabric cutting template is operative to provide a template for cutting one or more layers of fabric with a rotary cutter.

7. The fabric cutting template of claim 6, further comprising one or more markings on the cutting template, the markings comprising one or more reference lines equivalent to the triangular notch, the shorter cutting slot, and the longer cutting slot along one or more additional sides of the square body.

8. The fabric cutting template of claim 7, wherein the one or more markings further comprises cutting instructions, the cutting instructions comprised of one or more of: text, arrows, pictograms and combinations thereof.

9. The fabric cutting template of claim 6, wherein the square body is 10 inches along each side, the triangular notch is 2.68″ along each side, the shorter cutting slot is 3.05″ (total), and the longer cutting slot is 6.71″ (total)—long edges on pentagons are 3.66″.

10. A fabric cutting template, comprising:
a rigid planar rectangular body,
a first quadrilateral cutout, the first quadrilateral cutout positioned generally on one half of the body;
a second quadrilateral cutout, the second quadrilateral cutout positioned generally on a second half of the body, the second quadrilateral cutout having a same shape as the first quadrilateral cutout flipped vertically relative to the first quadrilateral cutout; and
a pair of cutting slots located along each edge of each of the first and the second quadrilateral cutouts,
wherein the fabric cutting template is operative to provide a template for cutting one or more layers of fabric with a rotary cutter into a set of quadrilateral pieces.

11. The fabric cutting template of claim 10, further comprising one or more markings on the cutting template, the markings additionally comprising cutting lines to indicate a position for removal of a triangular piece from each quadrilateral piece to provide a corresponding 5-sided piece of fabric.

12. The fabric cutting template of claim 11, wherein the one or more markings further comprises cutting instructions, the cutting instructions comprised of one or more of: text, arrows, pictograms and combinations thereof.
